(19) United States
(12) Patent Application Publication
(10) Pub. No.: US 2011/0138107 A1
(43) Pub. Date: Jun. 9, 2011

(54) USB NON-VOLATILE MEMORY SYSTEM FOR AN ELECTRONIC ENGINE CONTROLLER

(75) Inventors: Kimberly K. Sendlein, Marlborough, CT (US); James A. Gosse, Storrs, CT (US); Scott Beecher, Windsor, CT (US); Karin Averill Parker, Agawam, MA (US)

(73) Assignee: HAMILTON SUNDSTRAND CORPORATION, Windsor Locks, CT (US)

(21) Appl. No.: 12/633,287

(22) Filed: Dec. 8, 2009

(51) Int. Cl. G06F 12/00; G06F 12/02; G06F 1/26; G06F 1/32

(52) U.S. Cl. 711/103; 713/320; 711/E12.001; 711/E12.008

(57) ABSTRACT

An electronic engine controller has a processor, a data controller, and a non-volatile memory. During an engine operation, power is supplied to the processor, data controller, and non-volatile memory from an engine power source. Sensor data is received at the processor which supplies the sensor data to the data controller. The data controller stores the sensor data in the non-volatile memory. During data retrieval, power is supplied to the data controller and the non-volatile memory from a USB communications channel. The data controller retrieves the saved sensor data from the non-volatile memory and provides it to the USB communications channel.

### STATEMENT OF GOVERNMENT INTEREST

The U.S. Government has a paid-up license in this invention and the right in limited circumstances to require the patent owner to license others on reasonable terms as provided for by the terms of Contract No. F33365a7-99D-2051 awarded by the United States Air Force.

### BACKGROUND

The present invention relates to diagnostic engine data, and more specifically, the storage and retrieval of diagnostic engine data.

Engine controllers employed on aircraft store diagnostic data such as oil levels and various temperature readings to be later retrieved and analyzed for maintenance purposes. Typically, the diagnostic data is stored to non-volatile memory that preserves the data without a constant supply of power. However, power is required to retrieve the data from the non-volatile memory. In prior systems, a ground-based computer such as the Common Engine Transfer System (CETS) computer would be connected to the engine controller and an external power supply (such as a battery) provides power to the engine controller normally provided by an internal power source.

### SUMMARY

A method is provided for storing and retrieving engine data in an electronic engine control system that includes a processor, a data controller, and a non-volatile memory. During an engine operation, power is supplied to the processor, the data controller, and the non-volatile memory from an engine power source. Sensor data is received at the processor. The sensor data is supplied to the data controller for storage in the non-volatile memory. During data retrieval, power is supplied to the data controller and the non-volatile memory from a USB communications channel. The data controller retrieves the saved sensor data from the non-volatile memory and the sensor data is provided to the universal serial bus (USB) communications channel.

In another embodiment, an electronic engine control has a processor, a non-volatile memory, a USB communications channel, data controller, and a computing device. The processor is adapted to receive engine data from engine sensors. The non-volatile memory is adapted to store engine data. The data controller is adapted to receive engine data from the processor and provide the engine data to a non-volatile memory. The data controller is further adapted to retrieve the data from the non-volatile memory and provide it a USB communications channel. The computing device is connected to the electronic engine controller and configured to receive engine data from the USB communication channel. The data controller and the non-volatile memory are capable of being powered from the computing device.

An alternate embodiment is an engine data interface. The interface includes an interface connector a low power non-volatile memory, and a low power data controller. The interface connector has a power input, a ground input, and data conductor inputs. The low power data controller is adapted to supply data residing in the low power non-volatile memory to the data conductor inputs. The low power non-volatile memory and the low power data controller are adapted to draw power from the power and ground inputs supplied by a computing device connected to the interface connector.

### BRIEF DESCRIPTION OF THE DRAWINGS

FIG. 1 is a diagram illustrating data storage/retrieval associated with an electronic engine control according to an embodiment of the present invention.

FIG. 2 is a block diagram of the electronic engine controller according to an embodiment of the present invention.

FIG. 3 is a block diagram of the electronic engine controller according to another embodiment of the present invention.

### DETAILED DESCRIPTION

The present invention is directed to an electronic engine controller that stores diagnostic data received from a processor to non-volatile memory during normal operation. During a maintenance retrieval operation, internal power provided by the engine is not available. Sufficient power is drawn from the communication channel to power the non-volatile memory such that the diagnostic information can be retrieved without relying on a separate external power supply.

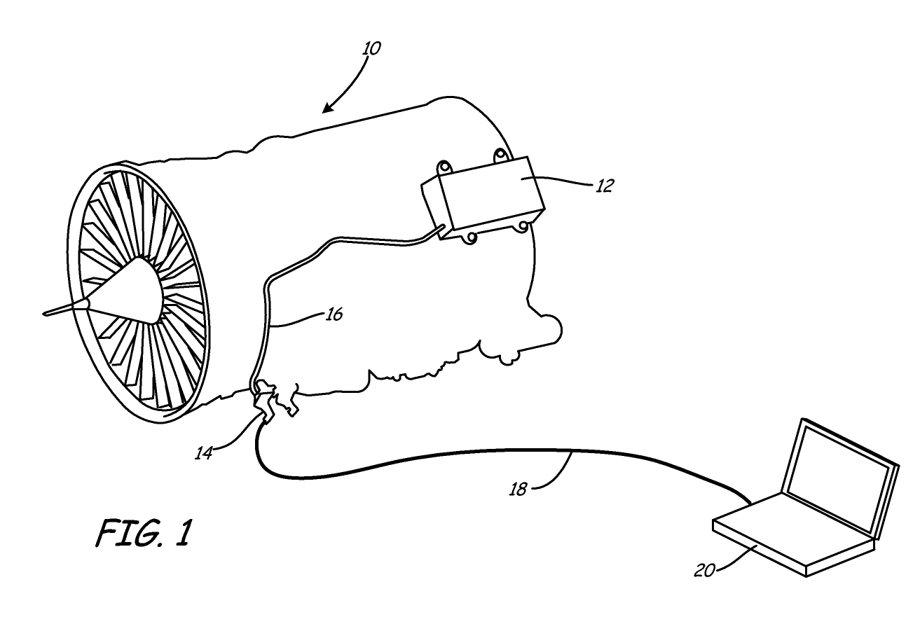

FIG. 1 is a diagram illustrating data storage/retrieval associated with an electronic engine control according to an embodiment of the present invention. Electronic engine controller 12 is connected to connector 14 by harnessing 16. Cable 18 connects computer 20 to connector 14 completing the connection from computer 20 to electronic engine controller 12. Connecter 14 may be a standard USB type connector or it may be a ruggedized connector. In the case of a ruggedized connector, cable 18 includes one ruggedized connector to mate with connector 14 and a standard USB connector to mate with computer 20. In all cases, cable 18 and harnessing 16 have sufficient conductors to carry power, ground and data conductors from the USB port on computer 20 to select portions of electronic engine controller 12 required for data retrieval.

In the embodiment shown in FIG. 1, a portable laptop computer is depicted, although in other embodiments, any computing device capable of supplying the rated power and data conductors may be used. One alternative example is a handheld computing device in which USB capabilities are employed. Particularly in the case of handheld devices, additional strain relief on the USB cable may be required to prevent damage to the USB port or cable connector.

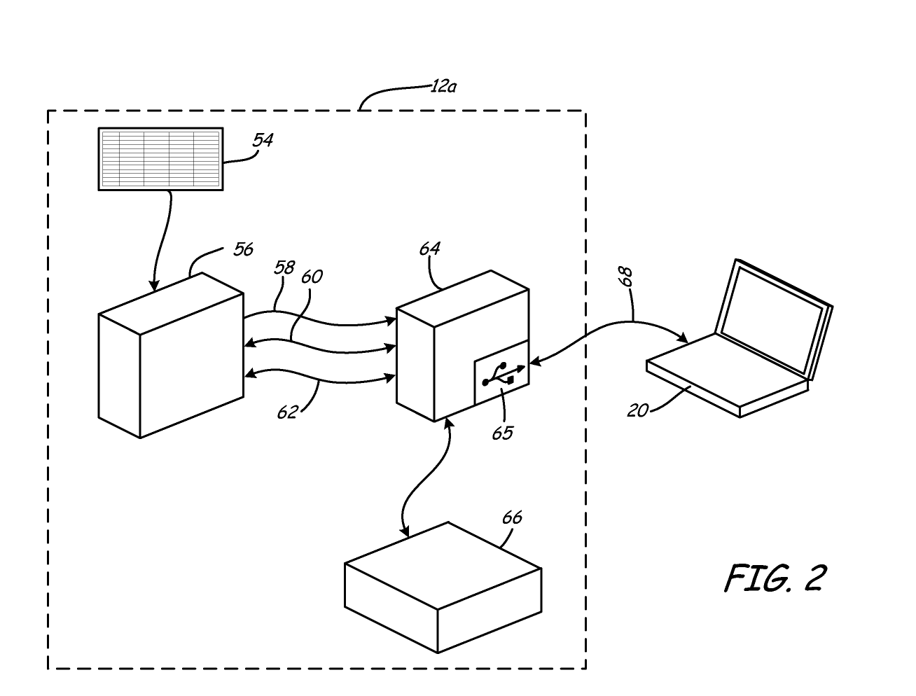

FIG. 2 is a block diagram of the electronic engine controller according to an embodiment of the present invention. Computer 20 is connected to electronic engine controller 12a. Diagnostic engine data 54 is processed by CPU 56. CPU 56 uses address lines 58, data lines 60, and control lines 62 to provide some or all of diagnostic engine data 54 to data controller 64a. Data controller 64a saves the data in non-volatile memory 66. It also recalls the data to transmit to computer 50 and can erase non-volatile memory 66 based on commands received from computer 50. Communications with computer 20 over USB connection 68 are accomplished using USB transceiver subcomponent 65a of data controller 64a. In some embodiments non-volatile memory 66 is NAND flash memory. Other media types such as conventional flash memory may also be used for non-volatile memory 66. NAND flash has an advantage of high storage densities (1-2 GB sizes available) and it is easily configured to work with USB.

During engine operations, CPU 56, data controller 64a, and non-volatile memory 66 are powered from an internal source derived from the engine. For retrieval of the data stored in non-volatile memory 66, engine power is not available. Data controller 64a and non-volatile memory 66 are powered from computer 50 eliminating the need for a separate battery.

There are significant power constraints in order to be able to power the electronic engine control from the USB port on the computer. There are also constraints presented from the environment where the device operates. A jet engine is subject to heat and vibration profiles not typically seen by USB devices.

USB is capable of providing 100 mA of current during initialization and 500 mA of total current to a device plugged into a USB port on a computing device. This is well below the requirements to supply power to all of the components of the electronic engine controller 12a (e.g. CPO 56, data controller 64a, non-volatile memory 66, etc). The present invention addresses this by making data controller 64a and non-volatile memory 66 capable of being independently powered from the USB connection 68. In this way, data may be retrieved from non-volatile memory 66 without having to supply power sufficient to operate all components of electronic engine controller 12a.

When the CPU 56 is turned off, all the signal lines (address lines 58, data lines 60, and control lines 62) between it and data controller 64a will be grounded. Positioning data controller 64a between CPU 56 and non-volatile memory 66 allows continued accessibility of the data stored in memory over USB connection 68. Keeping CPU 56 and the remainder of electronic engine controller 12a powered off reduces the power consumption to meet the available power requirements from the USB communications channel. This enables downloading engine data information with a simple USB connection. No additional battery is needed to power the entire electronic engine control.

Data controller 64a can provide two way access to non-volatile memory 66 over USB connection 68. This means that computer 20 can deposit instructions on non-volatile memory 66 for later operations such as system maintenance and fault clearing. When the CPU 56 is powered on again, it reads the memory and determines if any instructions have been saved to the non-volatile memory. Saved instructions are then carried out by CPU 56.

Non-volatile memory 66 can be configured to appear as a mass storage device on computer 20 like many readily available USB thumb drive devices. This provides for compatibility with a wide range of software applications running on computer 20 connected to electronic engine controller 12a. To prevent unauthorized access or storage of improper information, non-volatile memory 66 can be alternatively configured to have a special type identifier which requires a special driver provided by the device manufacturer. This ensures that non-volatile memory 66 is accessed for the proper purposes by authorized personnel. The use of NAND flash further facilitates compatibility with existing software architectures because it natively supports bad sector management, mapping of logical to physical storage addresses, and cell wear management.

In addition to the power restrictions from the USB requirements, the device operates in the environmental conditions present on a jet engine. Military grade electronics are preferable in this operating environment due to the expected wide temperature ranges. Commercial grade electronics have a rating of 0° to 70° C. Industrial grade parts are rated at −40° to 85° C. Military grade parts are rated at −55° to 125° C. To implement the present invention in such an environment, it may be necessary to use an integrated circuit for the data controller with a suitable temperature rating to provide needed functionality. Another method of ensuring proper operation is to test components at 125° C. to verify proper operation where the manufacturer rating is not sufficient and there are no alternatives.

Vibration profiles are also significantly different than in consumer electronics often using a quad flat pack no leads (QFN) or very fine ball grid array (VFBGA) packaging. A more rugged quad flat pack (QFP) package is preferable to ensure proper operation.

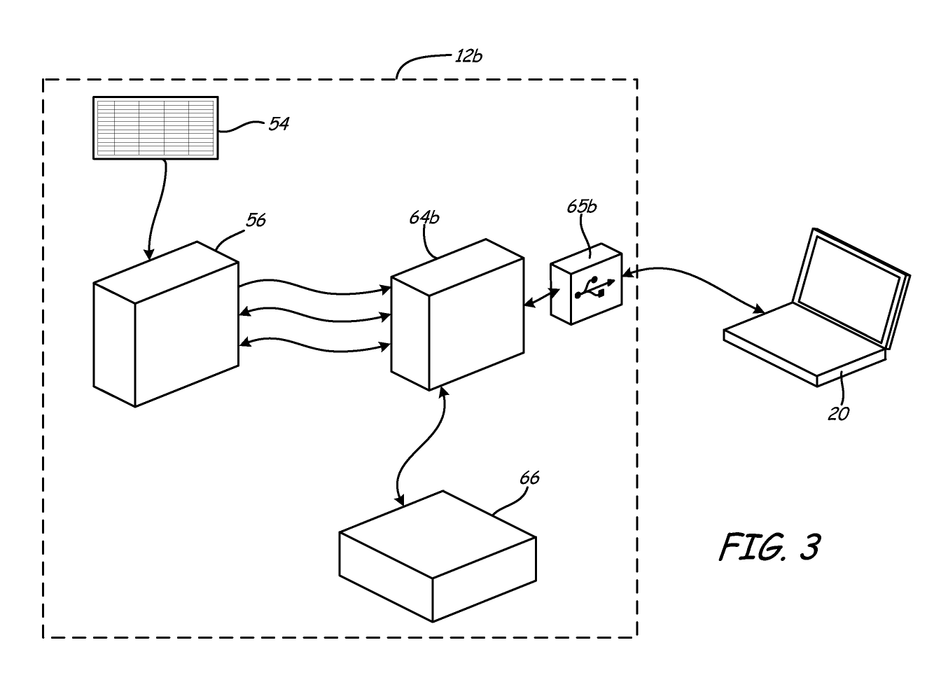

FIG. 3 is a block diagram of the electronic engine controller according to another embodiment of the present invention. Electronic engine control 12b includes data controller 64b and stand alone USB transceiver 65b. When data controller 64b has data to send to computer 20, it first provides it to USB transceiver 65b which in turn provides it to computer 20. The USB transceiver can be incorporated in the data controller (as in FIG. 2) or it can be a separate component (as in FIG. 3).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of storing and retrieving engine data in an electronic engine control system that includes a processor, a data controller, and a non-volatile memory, the method comprising:
during an engine operation:
supplying power to the processor, the data controller, and the non-volatile memory from an engine power source;
receiving sensor data at the processor; and
supplying the sensor data to the data controller for storage in the non-volatile memory;
during data retrieval:
supplying power to the data controller and the non-volatile memory from a USB communications channel;
retrieving, by the data controller, the saved sensor data from the non-volatile memory; and
providing the sensor data to the USB communications channel.

2. The method of claim 1 further comprising:
receiving, from the USB communications channel at the data controller, a set of data instructions;
storing the set of data instructions to the non-volatile memory; and
processing the set of data instructions in the processor during a next period of engine operation.

3. The method of claim 1 wherein providing the sensor data to the USB communications channel further comprises:
providing the sensor data from the data controller to a USB transceiver; and
providing the sensor data from the USB transceiver to the USB communications channel.

4. The method of claim 1 wherein the memory is NAND flash memory.

5. The method of claim 4 wherein the NAND flash memory has a storage capacity of at least 1 GB.

6. The method of claim 1 further comprising:
receiving the sensor data from the USB communications channel at a computing device.

7. The method of claim 6 wherein the computing device is a laptop computer.

8. The method of claim 1 wherein the data controller comprises quad flat pack terminals.

9. An electronic engine controller comprising:
a processor that receives engine data from engine sensors;
a non-volatile memory that stores engine data;
a communication channel; and
a data controller that receives the engine data from the processor and stores the engine data to the non-volatile memory, and that retrieves the engine data from the non-volatile memory and provide it to the communication channel;
wherein during data retrieval the data controller and the non-volatile memory derive power from an external source via the communication channel.

10. The electronic engine controller of claim 9 wherein
during data retrieval the data controller receives a set of data instructions from the communication channel and stores the data instructions to the non-volatile memory; and
subsequently during an engine operation the data controller retrieves the set of data instructions from the non-volatile memory and provides the set of data instructions to the processor.

11. The electronic engine controller of claim 9 wherein the communication channel is a universal serial bus.

12. The electronic engine controller of claim 11 further comprising a USB transceiver that receives the retrieved data from the data controller and provides it to the communications channel.

13. The electronic engine controller of claim 9 wherein the non-volatile memory has a storage capacity of at least 1 GB.

14. The electronic engine controller of claim 9 wherein the non-volatile memory is NAND flash.

15. An engine data interface comprising:
an interface connector having a power input, a ground input, and data conductor inputs;
a low power non-volatile memory; and
a low power data controller that supplies data residing in the low power non-volatile memory to the data conductor inputs;
wherein the low power non-volatile memory and the low power data controller are adapted to draw power from the power and ground inputs supplied by a computing device connected to the interface connector.

16. The engine data interface of claim 15 wherein the non-volatile memory is NAND flash.

17. The engine data interface of claim 15 wherein the low power data controller receives a set of processor instructions from the data conductors and stores the set of processor instructions in the low power non-volatile memory.

18. The engine data interface of claim 15 further comprising a USB transceiver connected between the low power data controller and the data conductor inputs.

19. The engine data interface of claim 15 further comprising a processor adapted to draw power from an engine power system and supply data to the low power data controller wherein the low power data controller stores the data in the low power non-volatile memory.

20. The engine data interface of claim 19 wherein the low power data controller receives a set of instructions from the data conductor inputs, stores the set of instructions in the low power non-volatile memory, and at a later time, retrieves the set instructions in the low power non-volatile memory and provides the set of instructions to the processor.
